(19) United States
(12) Patent Application Publication
(10) Pub. No.: US 2017/0193410 A1
(43) Pub. Date: Jul. 6, 2017

(54) ALTERNATIVE CHANNEL SELECTION BASED ON PREDICTIVE WORK FLOW

(71) Applicant: BANK OF AMERICA CORPORATION, Charlotte, NC (US)

(72) Inventors: Alicia C. Jones-Mc-Fadden, Fort Mill, SC (US); Matthew Hsieh, Charlotte, NC (US); Gail Mohr, Menlo Park, CA (US); Linda Yoon Lentz, San Jose, CA (US)

(21) Appl. No.: 14/987,696

(22) Filed: Jan. 4, 2016

(51) Int. Cl. G06Q 10/06; G06Q 30/02

(52) U.S. Cl. CPC G06Q 10/0633; G06Q 30/0201

(57) ABSTRACT

Systems, methods and computer program products are disclosed for managing work flow associated with a resource, location and/or channel. The system receives transaction history information identifying transactions performed by an entity in the past and identifies a pattern for a recurring transaction performed by the entity via the resource, location and/or channel. The system predicts a future instance when the entity will likely perform the recurring transaction at the resource, location and/or channel again. The system receives work flow information associated with the resource, location and/or channel indicating historical work flow delays and identifies, based on the historical work flow, an estimated delay associated with processing the recurring transaction at the predicted instance in the future. The system identifies an alternate resource, location and/or channel for performing the recurring transaction at the predicted instance in the future and presents the alternative as a potential alteration of work flow.

### FIELD OF THE INVENTION

The current invention relates to monitoring of work flow or potential work flow for a given resource, location or channel and providing suggestions for use of alternative resources, locations, or channels to balance workloads.

### BACKGROUND

Work flow management across various resources is critical for proper processing of work and work load balance. Many corporations have more than one resource, location, or channel that may perform a particular work flow. However, without management, work flow may be targeted to a particular resource, location, and/or channel. What is needed is systems for load balancing and redirection to other resources, locations, and/or channels capable of performing the work.

### BRIEF SUMMARY

Systems, methods and computer program products are disclosed for managing work flow associated with a resource, location and/or channel. The system receives transaction history information identifying transactions performed by an entity in the past and identifies a pattern for a recurring transaction performed by the entity via the resource, location and/or channel. The system predicts a future instance when the entity will likely perform the recurring transaction at the resource, location and/or channel again. The system receives work flow information associated with the resource, location and/or channel indicating historical work flow delays and identifies, based on the historical work flow, an estimated delay associated with processing the recurring transaction at the predicted instance in the future. The system identifies an alternate resource, location and/or channel for performing the recurring transaction at the predicted instance in the future and presents the alternative as a potential alteration of work flow.

As an example, embodiments of the invention are directed to systems, methods and computer program products for managing waiting times at a physical location of a service provider. In some embodiments, the invention is configured to receive historical transaction information identifying transactions performed by a customer; identify, from the transaction information, a pattern for a recurring transaction performed by the customer while at a physical location of a service provider; determine an instance in the future when the customer will likely perform the recurring transaction at the physical location of the service provider; receive waiting time information identifying typical waiting times at the physical location of the service provider; identify, based on the waiting time information, an estimated waiting time for performing the recurring transaction during a period of time associated with the instance in the future when the customer will likely perform the recurring transaction; identify, based on the waiting time information, an alternate time period comprising a waiting time less than the estimated waiting time; and present, to the customer, a notification comprising the estimated waiting time for performing the recurring transaction during the period of time associated with the instance and the waiting time associated with the alternate time period, thereby managing the waiting times of the physical location of the service provider.

In some embodiments, the notification further provides a guarantee for a waiting time that is less than the estimated waiting time. Further, the invention may be configured to receive a response that the customer has accepted the guarantee for the waiting time that is less than the estimated waiting time. The invention may identify the customer has arrived at the physical location of the service provider during the alternate time period. The invention may then notify the agent of the service provider that the customer has arrived at the physical location of the service provider and that the customer has accepted the guaranteed for the waiting time that is less than the estimated waiting time.

In other embodiments, the notification further comprises an estimated waiting time for an alternate physical location of the service provider.

The invention may be configured to identify that the customer is capable of performing the recurring transaction using a remote application. Presenting the notification to the customer further comprises a set of instructions informing the customer how to perform the recurring transaction using the remote application.

While in other embodiments, the invention may be configured to establish a data connection between a computing device of the customer and a computing device of a remote agent of the financial institution capable of completing the recurring transaction. The data connection transmits a multimedia signal that is presented on the computing device of the customer and the computing device of the remote agent. Therefore, the invention allows the remote agent to assist the customer in completing the recurring transaction.

In some embodiments, the invention may be configured to receive a geographic location of the customer determined by a mobile device of the customer. The mobile device of the customer determines the geographic location of the customer by communicating with a global positioning device. The invention may then calculate an estimated travel time for the customer to arrive at the physical location of the service provider based on the traffic information of the area between the geographic location of the customer and the physical location of the service provider. Finally, the invention may communicate the estimated travel time for the customer to arrive at the physical location of the service provider.

### BRIEF DESCRIPTION OF THE DRAWINGS

Having thus described embodiments of the invention in general terms, reference will now be made to the accompanying drawings, where:

FIG. 1 illustrates technical components of a system for serving a customer at a facility, in accordance with an embodiment of the invention;

FIG. 2 illustrates a general process flow for mobile device configuration based on transaction history context, in accordance with an embodiment of the invention;

FIG. 3 illustrates a process flow for modifying a customer interface based on user selection, in accordance with an embodiment of the invention;

FIG. 4 illustrates a process flow associated with modifying an appointment time for a customer;

FIG. 5A illustrates a mobile device application interface for providing a user with interactive information relative to a transaction/engagement with a financial center location;

FIG. 5B illustrates a mobile device application interface for providing a user with interactive information relative to a transaction/engagement while remote; and

FIG. 5C illustrates a mobile device application interface for providing a user with interactive information relative to a transaction/engagement illustrating availability/wait times for channel resources.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In general, the invention is directed to systems, methods and computer program products for monitoring user activities relative to a particular resource, location and/or channel, such as online banking, financial transactions, current location, route, on-line queries, etc. to determine a possibility that the user may be using a resource, location, or channel in the future. The system may review account records to spot potential problems in the account that may indicate that the user may access a resource, location or channel. The system also predicts the user's reason for performing a transaction. For example, the user may be visiting bank branch to execute a transaction (e.g., deposit checks), complete a partial transaction previously initiated by the user using the mobile device (e.g., open a new account), or resolve an issue with one of the user's accounts. The system may retrieve information associated with the user's previous visits and identify a pattern for the reasons that the user may visit the bank branch in the future. The system may then present on a user interface of the mobile device of the user, the predicted options for the user's visit to the bank. The user may choose from the options, the user's reason for the visit. Once the user's option is received, the system then provides recommendations to enable the user to execute the transaction in a more efficient manner (e.g., remotely via the mobile device). In one aspect, the recommendation includes incentives for the user to utilize the latest available technology to execute the transaction. The system may track the user for a predetermined amount of time after the visit to see whether the user continues to use the latest available technology to execute the transaction. In some cases, the system may provide a tutorial video to help the user execute the transaction.

Conventional systems attempt to predict when a user may visit a branch location based on current location of a user, such as by monitoring a user's mobile device. While a helpful predictor, if the bank branch is along a path of travel used by the customer frequently, it may not provide much insight as prediction on when the customer intends to visit a bank branch.

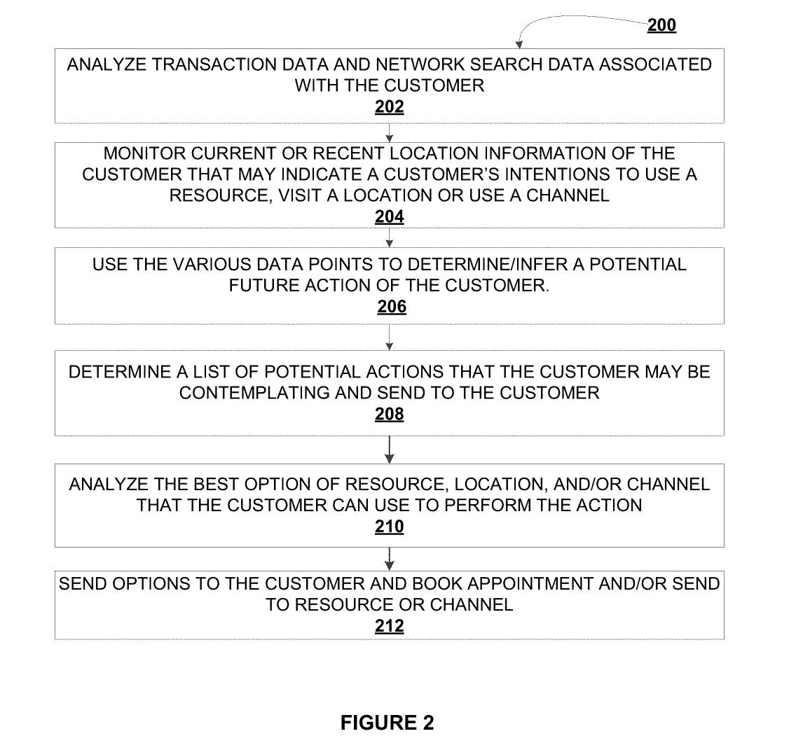

The present invention, on the other hand, uses historical data related to the customer to aid in predicting a potential issue that the customer may be experiencing and a potential that the customer may be using a resource, visiting a location or using a channel of the bank to address the issue. For example, with reference to FIG. 2, the system may analyze transaction data associated with the customer. (See block 202). As an example, the customer may have several transactions, such as personal credit checks, payments to a lawyer or real estate agent, abnormal numbers of purchases at a home improvement center, etc. that indicate that the customer may be contemplating the sale of a home. The system may also receive network data from searches by the customer indicating that the customer is searching for a new home, a law firm, or real estate agent, loan calculators, etc., which indicates that the customer may be buying a new home and need a loan. The system may also review interactions of the customer with the bank's website, such as filling out a loan application and the like. (See block 202).

In addition to review of a customer's historical financial data and search data, the system may also monitor current or recent location information of the customer that may indicate a customer's intentions to use a resource, visit a location or use a channel. (See block 204). This could be GPS data indicating that the customer is near a bank branch or ATM. It could be the user accessing an online service, such as an online loan application, online banking application, etc.

Using these various data points, the system then uses a logic engine or logic tree to determine/infer a potential future action of the customer. (See block 206). The logic engine may employ fuzzy logic, neural networks, algorithms, heuristics, etc. to determine future predicted actions of the customer. (See block 208). In some embodiments, the system may determine a list of potential actions that the customer may be contemplating, such as paying off their current mortgage, applying for a new mortgage, setting up an escrow account, moving to a new city, etc.

Once the system has predicted one or more potential future actions of the customer, the system may send a notification to the user via email, text message, online banking message, phone call, etc. asking the customer if they are planning to perform one of the predicted actions, and possibly what resource, location, or channel that the customer intends to use. (See block 208). Based on feedback from the customer, the system then analyzes the best option of resource, location, and/or channel that the customer can use to perform the action. (See block 210). The system may determine from the customer future action various attributes that require specific resources of the bank, such as a loan officer, online mortgage application, etc. The system may determine whether the transaction can be handled completely by one resource, location and/or channel or whether a combination of resources is needed to complete the customer's predicted action. The system may also review traffic pattern data and work flow volumes associated with the selected resource, location, and/or channel to determine the best times for the customer to perform the predicted action. The options may be transmitted to the customer via email, text message, online banking message, phone call, etc. to allow the customer to select and schedule times for the action. The system then calendars appointments for the customer to perform the action. (See block 212).

In some instances, the system may direct the user to use a new channel, online or mobile technology not used by the customer before to complete the predicted action. This may be to introduce and entice the customer to use more efficient resources, locations, and/or channels for a banking matter. The system may provide incentives for the customer to use the new tools. The system may track the customer for a predetermined amount of time after the visit to see whether the customer continues to use the latest available technology to execute the transaction. In some cases, the system may provide a tutorial video to help the user execute the transaction.

As mentioned above, embodiments of the invention are directed to systems, methods and computer program products for managing work flow with regard to resources, locations, and channels, such as increasing through put on an electronic channel, such as banking application or decreasing wait times at a physical location, such as a bank branch. As an example, the invention may analyze transactions performed by a customer while at a physical location of a service provider to identify a routine transaction normally performed by the customer. The invention determines a time in the future that the customer will likely enter the physical location of the service provider to perform the transaction. The invention communicates with the service provider to determine typical wait times at the physical location of the service provider at various times of the day or days of the week. The invention may determine based on this information that the customer will likely enter the physical location of the service provider at a time when there is a higher than normal wait time. The invention may communicate with a computing device of the customer to suggest an alternative time when the customer could pass by the financial institution to perform the transaction. Alternatively, the invention may determine that the transaction may be performed using an alternative tool. For example, the alternative tool could be an online platform that allows the customer to perform the transaction. The invention may provide instructions to the customer on performing the transaction using the alternative tool. While yet in other embodiments, the invention may identify an alternative physical location that the customer could visit to perform the transaction.

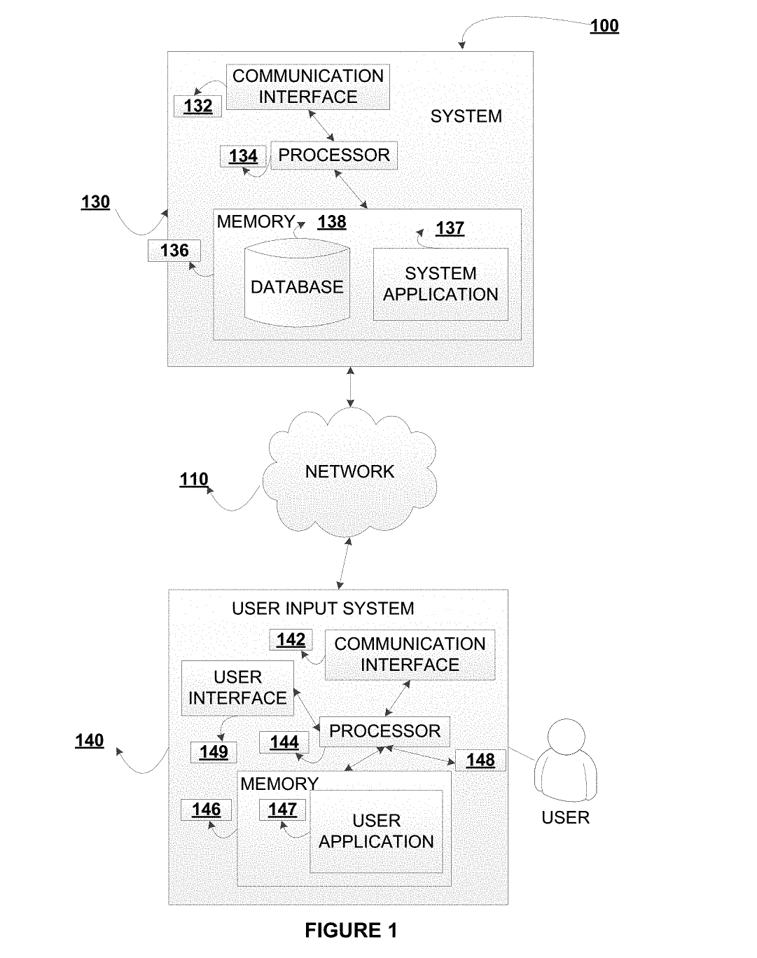

FIG. 1 presents an exemplary block diagram of the system environment 100 for implementing the process flows described herein in accordance with embodiments of the present invention. As illustrated, the system environment 100 includes a network 110, a system 130, and a user input system 140. Also shown in FIG. 1 is a user of the user input system 140. The user input system 140 may be a mobile device or other non-mobile computing device. The user may be a person who uses the user input system 140 to execute a user application 147. The user application 147 may be an application to communicate with the system 130, perform a transaction, input information onto a user interface presented on the user input system 140, or the like. The user application 147 and/or the system application 137 may incorporate one or more parts of any process flow described herein.

As shown in FIG. 1, the system 130, and the user input system 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may also include wireless and/or wired and/or optical interconnection technology.

The user input system 140 may include any computerized apparatus that can be configured to perform any one or more of the functions of the user input system 140 described and/or contemplated herein. For example, the user may use the user input system 140 to transmit and/or receive information or commands to and from the system 130. In this regard, the system 130 may be configured to establish a communication link with the user input system 140, whereby the communication link establishes a data channel (wired or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, or the like. In some embodiments, for example, the user input system 140 may include a personal computer system (e.g. a non-mobile or non-portable computing system, or the like), a mobile computing device, a personal digital assistant, a mobile phone, a tablet computing device, a network device, and/or the like. As illustrated in FIG. 1, in accordance with some embodiments of the present invention, the user input system 140 includes a communication interface 142, a processor 144, a memory 146 having an user application 147 stored therein, and a user interface 149. In such embodiments, the communication interface 142 is operatively and selectively connected to the processor 144, which is operatively and selectively connected to the user interface 149 and the memory 146. In some embodiments, the user may use the user application 147 to execute processes described with respect to the process flows described herein. Specifically, the user application 147 executes the process flows described herein.

Each communication interface described herein, including the communication interface 142, generally includes hardware, and, in some instances, software, that enables the user input system 140, to transport, send, receive, and/or otherwise communicate information to and/or from the communication interface of one or more other systems on the network 110. For example, the communication interface 142 of the user input system 140 may include a wireless transceiver, modem, server, electrical connection, and/or other electronic device that operatively connects the user input system 140 to another system such as the system 130. The wireless transceiver may include a radio circuit to enable wireless transmission and reception of information. Additionally, the user input system 140 may include a positioning system. The positioning system (e.g. a global positioning system (GPS), a network address (IP address) positioning system, a positioning system based on the nearest cell tower location, or the like) may enable at least the user input system 140 or an external server or computing device in communication with the user input system 140 to determine the location (e.g. location coordinates) of the user input system 140.

Each processor described herein, including the processor 144, generally includes circuitry for implementing the audio, visual, and/or logic functions of the user input system 140. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 147 of the memory 146 of the user input system 140.

Each memory device described herein, including the memory 146 for storing the user application 147 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

As shown in FIG. 1, the memory 146 includes the user application 147. In some embodiments, the user application 147 includes an interface for communicating with, navigating, controlling, configuring, and/or using the user input system 140. In some embodiments, the user application 147 includes computer-executable program code portions for instructing the processor 144 to perform one or more of the functions of the user application 147 described and/or contemplated herein. In some embodiments, the user application 147 may include and/or use one or more network and/or system communication protocols.

Also shown in FIG. 1 is the user interface 149. In some embodiments, the user interface 149 includes one or more output devices, such as a display and/or speaker, for presenting information to the user. In some embodiments, the user interface 149 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user. In some embodiments, the user interface 149 includes the input and display devices of a mobile device, which are operable to receive and display information.

FIG. 1 also illustrates a system 130, in accordance with an embodiment of the present invention. The system 130 may refer to the “apparatus” described herein. The system 130 may include any computerized apparatus that can be configured to perform any one or more of the functions of the system 130 described and/or contemplated herein. In accordance with some embodiments, for example, the system 130 may include a computer network, an engine, a platform, a server, a database system, a front end system, a back end system, a personal computer system, and/or the like. Therefore, the system 130 may be a server managed by the business. The system 130 may be located at the facility associated with the business or remotely from the facility associated with the business. In some embodiments, such as the one illustrated in FIG. 1, the system 130 includes a communication interface 132, a processor 134, and a memory 136, which includes a system application 137 and a structured database 138 stored therein. As shown, the communication interface 132 is operatively and selectively connected to the processor 134, which is operatively and selectively connected to the memory 136.

It will be understood that the system application 137 may be configured to implement any one or more portions of the various user interfaces and/or process flow described herein. The system application 137 may interact with the user application 147. It will also be understood that, in some embodiments, the memory includes other applications. It will also be understood that, in some embodiments, the system application 137 is configured to communicate with the structured database 138, the user input system 140, or the like.

It will be further understood that, in some embodiments, the system application 137 includes computer-executable program code portions for instructing the processor 134 to perform any one or more of the functions of the system application 137 described and/or contemplated herein. In some embodiments, the system application 137 may include and/or use one or more network and/or system communication protocols.

In addition to the system application 137, the memory 136 also includes the structured database 138. As used herein, the structured database 138 may be one or more distinct and/or remote databases. In some embodiments, the structured database 138 is not located within the system and is instead located remotely from the system. In some embodiments, the structured database 138 stores information or data described herein.

It will be understood that the structured database 138 may include any one or more storage devices, including, but not limited to, datastores, databases, and/or any of the other storage devices typically associated with a computer system. It will also be understood that the structured database 138 may store information in any known way, such as, for example, by using one or more computer codes and/or languages, alphanumeric character strings, data sets, figures, tables, charts, links, documents, and/or the like. Further, in some embodiments, the structured database 138 may include information associated with one or more applications, such as, for example, the system application 137. It will also be understood that, in some embodiments, the structured database 138 provides a substantially real-time representation of the information stored therein, so that, for example, when the processor 134 accesses the structured database 138, the information stored therein is current or substantially current.

It will be understood that the embodiment of the system environment illustrated in FIG. 1 is exemplary and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

In addition, the various portions of the system environment 100 may be maintained for and/or by the same or separate parties. It will also be understood that the system 130 may include and/or implement any embodiment of the present invention described and/or contemplated herein. For example, in some embodiments, the system 130 is configured to implement any one or more of the embodiments of the process flows described and/or contemplated herein in connection any process flow described herein. Additionally, the system 130 or the user input system 140 is configured to initiate presentation of any of the user interfaces described herein.

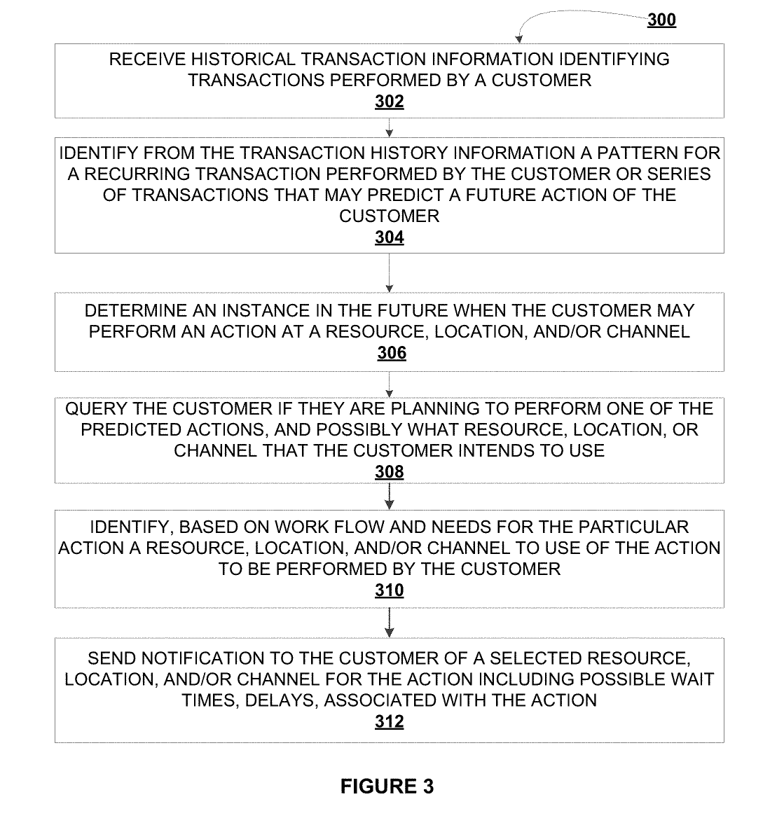

FIG. 3 illustrates a high level process flow for mobile device configuration based on transaction history context 300, in accordance with an embodiment of the invention. As shown in block 302, the process flow includes receiving historical transaction information identifying transactions performed by a customer. The information may include date and time information, a type of the transaction, financial information of the transaction, and a service provider or merchant that the transaction was performed with, etc. In some embodiments, the transaction information may be related to a specific service provider or merchant with whom the transactions were completed. The merchant or service provider may track and store such information. Such information may be stored as electronic receipts that include the transaction information. In other embodiments, the transaction information may be financial transaction information received from a financial institution. The financial information may be a bank statement, or a list of financial transactions. The financial information may include the merchant or service provider with whom the transaction, date and time information of the transaction, and other financial information related to the transaction. In yet other embodiments, the service provider may be the financial institution and the transaction may relate to financial transactions. These financial transactions may include any typical financial transaction typically performed by a financial institution, which may include, but are not limited to, deposits, withdrawals, transfers, loans, and the like. The financial institution may track additional information related to the transaction which may include account information.

As illustrated in block 304, the process flow includes identifying from the transaction history information a pattern for a recurring transaction performed by the customer or a series of transactions that may be a predictor that the customer plans to use a particular resource, location and/or channel. The pattern may be identified based on date and time information of the transactions within the transaction history information. For example, the transaction history information may include transactions for the customer where the customer performed a recurring transaction on a given day each week with a particular resource, location and/or channel. In other embodiments, the pattern may be based on another parameter. For example, where the service provider is a financial institution, the transaction may be a transfer of funds from a first account to a second account. The pattern may indicate that the customer transfers the funds when the second account reaches a given threshold. In some embodiments, a determination may be made to identify a transaction that the customer normally performs in conjunction with the recurring transaction (e.g. pays a bill, views an account balance). The analysis may also or instead review a plurality of transactions that may be interrelated in some way to potential future action, such as transactions that indicate that the customer may be preparing to buy a car, buy or sell a house, open a new account, start an investment account, etc.

As illustrated in block 306, the process flow includes determining an instance in the future when the customer will likely perform an action at a resource, location and/or channel. Such a determination may be made based on the data analysis in block 304. The system may look for a pattern in the data based on a time period, determining the instance may be a prediction based on a day or time when the customer is likely to enter the physical location of the service provider. This may be based on any time period, which may include, but is not limited to daily, weekly, monthly, quarterly, annually, and the like. For example, a pattern may be identified that a customer typically enters the physical location of the service provider on a daily basis at within a two-hour block in the afternoon. In other embodiments where the pattern is based on an outside parameter, a time period may be identified when a threshold associated with the outside parameter would be exceeded. For example, where the customer transfers funds from a first account to a second account when an amount in the first account exceeds a given threshold, a determination may be made that it typically takes two weeks for the threshold to be exceeded from the last time a transfer was made. Therefore, a determination may be made that the customer will enter the financial institution two weeks after the last time a transfer was made. While in other embodiments, further monitoring of the outside parameter may be performed to determine when the customer would likely enter the physical location of the service provider to perform the transaction. For example, where the transaction is a transfer of funds from a first account to a second account when a balance of the first account exceed a given threshold, monitoring may be performed on the balance of the first account to determine when the customer would likely enter the physical location of the service provider. In yet other embodiments, a determination may be made as to the physical location of the service provider. In some instances, the customer may prefer to only perform the recurring transaction at a single physical location of the service provider. Where in other instances, the customer may prefer to perform the transaction at a physical location that is closest to the customer at the time. While in other instances, a relation may be made to physical addresses of the customer and the physical locations of the service provider. Such physical addresses may identify an address of a home of the user, or an address of the work of the customer.

As mentioned above, the system may study the data to determine a pattern of related transactions that may be a predictor of a future actions, such as a series of transactions that would indicate that customer is taking a future action, such as applying for a mortgage. Using these various data points, the system then uses a logic engine or logic tree to determine/infer a potential future action of the customer. (See block 306). The logic engine may employ fuzzy logic, neural networks, algorithms, heuristics, etc. to determine future predicted actions of the customer. In some embodiments, the system may determine a list of potential actions that the customer may be contemplating, such as paying off their current mortgage, applying for a new mortgage, setting up an escrow account, moving to a new city, etc.

Once the system has predicted one or more potential future actions of the customer, the system may send a notification to the user via email, text message, online banking message, phone call, etc. asking the customer if they are planning to perform one of the predicted actions, and possibly what resource, location, or channel that the customer intends to use. (See block 308). Based on feedback from the customer, the system then analyzes the best option of resource, location, and/or channel that the customer can use to perform the action. (See block 310). The system may determine from the customer future action various attributes that require specific resources of the bank, such as a loan officer, online mortgage application, etc. The system may determine whether the transaction can be handled completely by one resource, location and/or channel or whether a combination of resources is needed to complete the customer's predicted action. The system may also review traffic pattern data and work flow volumes associated with the selected resource, location, and/or channel to determine the best times for the customer to perform the predicted action. The options may be transmitted to the customer via email, text message, online banking message, phone call, etc. to allow the customer to select and schedule times for the action. The system then calendars appointments for the customer to perform the action. (See block 312).

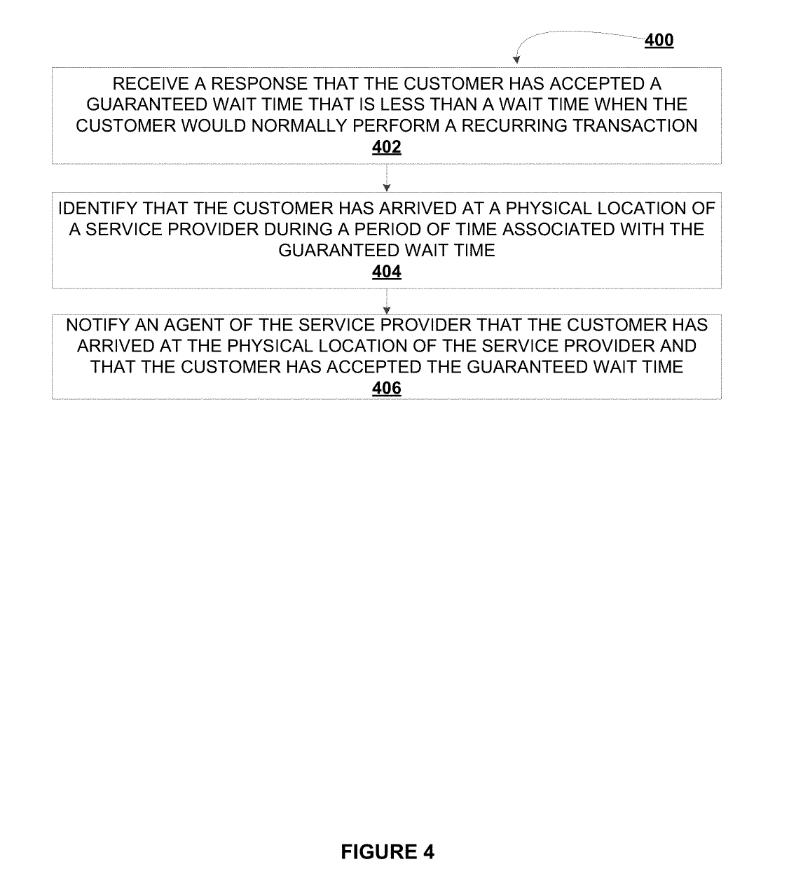

FIG. 4 presents a process flow for providing a shortened wait time to a customer should the customer arrive at a physical location of the service provider at a specified period of time. At illustrated in Block 402, the process flow may receive a response that the customer has accepted a guaranteed wait time that is less than a wait time when the customer would normally perform a recurring transaction at a physical location of the service provider. A notification may be sent to the customer. Such notification may further include a guarantee that should the customer arrive at the physical location of the service provider, the customer would have a guaranteed wait time. The notification may allow the customer to accept such a guarantee. This guarantee may be communicated to a customer management system. The system may analyze the number of guarantees that are accepted to determine the number of customers that may enter the physical location of the financial institution at a particular time period. Such a system may use wait time information communicated by the service provider to create the guarantees. The system may further include information related to agents or employees that are presently working at the physical location of the service provider that would be able to complete the transaction of the customer. As an example, wait time information of a service provider may identify a period of time in a given day with a low wait time. Additional information may identify that a physical location of the service provider will have one employee that is capable of handling a particular transaction. Using this information, the customer management system may provide guarantees to a select number of customers. Should some of the customers not accept the guarantee within an expiry time period, the system may create additional guarantees for other customers. Thus, the system is capable of managing when customers would likely enter a financial institution.

As illustrated in block 404, the process flow may identify that the customer has arrived at the physical location of the service provider during a period of time associated with the guaranteed wait time. In some embodiments, a location of the user may be determined. The location may be based on a mobile device detecting the location of the user. In some instances, the mobile device is configured to communicate with a Global Positioning System (GPS) device. In other instances, the mobile device may be determined based on a given Wireless network to which the mobile device may be connected. While in other embodiments, the location of the mobile device may be based on triangulating the wireless device using broadcast signals from wireless connection points to which the mobile device may be connected. In addition to determining the location of the user based on a mobile device of the user, the location may be determined by communicating with a social networking interface to which the user is a member. Messaging feeds may be analyzed to determine location information. The location information may be meta data associated with a message or may be contained in the message as described by the user or a third person. The location may be defined as an actual geographical location (e.g. city, country), or may be a reference to an actual location (e.g. the bank). Where the location information is a reference to an actual location, further analysis may be performed to identify the location based on previous location history of the user. For example, from previous messages, the term “bank” may be associated with a particular physical location of a financial institution. Additionally, the location information may be compared against an actual location of the user to determine the validity of the location based on social network messages. In any case, after the location of the user is determined, the location is compared to a location of the physical location of the merchant. In some embodiments, a comparison is made to determine whether the user is within a predetermined distance of the physical location of the merchant. In other embodiments, a determination is made as to a direction of travel of the user and whether such direction of travel is towards the physical location of the merchant. Based on the comparison between the location of the user and the physical location of the service provider, a determination may be made as to whether the user has arrived at the physical location of the service provider.

Further illustrated in block 406, the process flow may notify an agent or employee of the service provider that the customer has arrived at the physical location of the service provider and that the customer has accepted the guaranteed wait time. The notification may be sent to a computing device of the agent of the service provider. In some instances the notification may further include a transaction that the user is likely to perform. After receiving the notification, the agent may be prepared to assist the customer.

Additionally, a notification may be sent to the customer after the customer has arrived at the physical location of the service provider that the customer is checked-in.

In some embodiments, the guarantee may have an expiration period for acceptance.

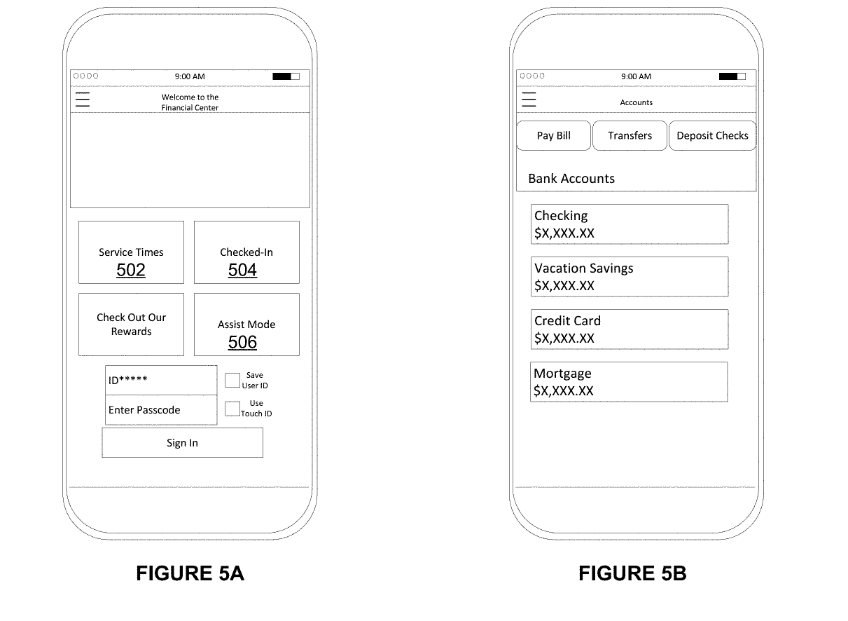

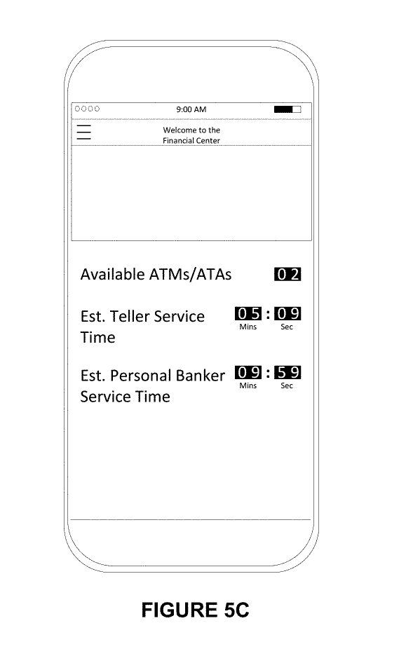

The invention also contemplates online banking and mobile device application services to assist the customer either at a banking location or a customer contemplating a visit to a banking location. For example, the invention provides a mobile experience integrated into the financial institution online or mobile banking application that adapts the presentation of the application and provides information to the customer based on a customer's location, needs and behaviors. As shown in FIG. 5A, in the financial center location, the application delivers guidance, assistance and contextual information to enable transactions/engagements in the financial center location. These include: 1) financial location check-in 502, 2) service times 504, and 3) assist mode 506. Away from the financial center location, as shown in FIG. 5B, the application delivers remote functions, features and contextual information.

Regarding FIG. 5A, when the customer enters or is near a financial center location, the customer may be prompted or otherwise select to check-in either via the application or via a social media application. The customer is then presented with 1) financial location check-in 502, 2) service times 504, and 3) assist mode 506. The financial location check-in 502 provides status information regarding the customer's status, previous history at the financial center location, etc.

As shown in FIG. 5C, the service times 504 function shows various wait times for automate teller machines and automated teller assist machines, estimated teller availability, and personal banker availability. This information is gathered electronically by the system form the financial center data center that tracks availability and service times for various resources. Service times can be presented in and out of the financial center. Presenting service times outside of the financial center allow for push recommendations based on customer patterns, service times and availability. Self-service options such as ATM and ATA availability provide customers with an alternate choice. Providing estimated service times drive choice based on availability, time saves and comparisons across servicing options.

Assist mode is part of the mobile device application that, when in proximity to the a financial center location, will dynamically change by offering an assist mode button that gives instructions for self service, new product descriptions, digital forms etc. that the customer may need for a transaction/engagement with the financial center location. For example, the system may predict that a customer is coming to the financial center for a particular issue and dynamically change the application interface to provide information regarding the predicted customer transaction/engagement. The system could also include a banking concierge that may activate a service call/text/request to a financial institution resource associated with the customer transaction/engagement.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. Patent Application | | |
|---|---|---|---|
| Docket Number | Ser. No. | Title | Filed On |
| 6952US1.014033.2574 | To be assigned | MOBILE APPLICATION | Concurrently |
| | | CONFIGURATION | herewith |
| | | BASED ON | |
| | | GEOGRAPHIC AND | |
| | | TRANSACTION | |
| | | HISTORY CONTEXT | |
| 6954US1.014033.2575 | To be assigned | WORK FLOW | Concurrently |
| | | SCHEDULE | herewith |
| | | RECONCILIATION AND | |
| | | DATA PUSH | |
| 6957US1.014033.2576 | To be assigned | MALFEASANCE | Concurrently |
| | | DETECTION BASED ON | herewith |
| | | IDENTIFICATION OF | |
| | | DEVICE SIGNATURE | |
| 6956US1.014033.2577 | To be assigned | RECURRING EVENT | Concurrently |
| | | ANALYSES AND DATA | herewith |
| | | PUSH | |
| 6953US1.014033.2578 | To be assigned | ALTERNATIVE | Concurrently |
| | | CHANNEL SELECTION | herewith |
| | | BASED ON PREDICTIVE | |
| | | WORK FLOW | |

What is claimed is:

1. A system for managing work flow associated with a resource, location and/or channel, the system comprising:
a memory;
one or more processors;
a module stored in memory, when executed by the one or more processors, causes the one or more processors to:
receive transaction history information identifying transactions performed by an entity in the past;
identify from the transaction history information a pattern for a recurring transaction performed by the entity via the resource, location and/or channel;
predict an instance in the future when the entity will likely perform the recurring transaction at the resource, location and/or channel;
receive work flow information associated with the resource, location and/or channel indicating historical work flow delays;
identify, based on the historical work flow, an estimated delay associated with processing the recurring transaction at the predicted instance in the future at the resource, location and/or channel;
identify an alternate resource, location and/or channel for performing the recurring transaction at the predicted instance in the future; and
presenting a notification comprising the estimated delay associated with processing the recurring transaction at the predicted instance in the future at the resource, location and/or channel and indicating the alternate resource, location and/or channel for performing the work.

2. A system for managing work flow at resource, location, and/or channel, the system comprising:
a memory;
one or more processors;
a module stored in memory, when executed by the one or more processors, causes the one or more processors to:
receive transaction history information identifying transactions performed by a customer;
identify from the transaction history information a pattern for a recurring transaction performed by the customer with a given resource, location and/or channel;
determine an instance in the future when the customer will likely perform the recurring transaction;
receive work flow information associated with the resource, location, and/or channel that the customer has used in the past for the recurring transaction;
identify, based on the work flow information, an estimated waiting time for performing the recurring transaction during a period of time associated with the instance in the future when the customer will likely perform the recurring transaction;
identify, based on the work flow information, an alternate time period comprising a waiting time that is less than the estimated waiting time; and
present, to the customer, a notification comprising the estimated waiting time for performing the recurring transaction during the period of time associated with the instance and the waiting time associated with the alternate time period, thereby managing the waiting times of the physical location of the service provider.

3. The system of claim 2, wherein the notification further provides a guarantee for a waiting time that is less than the estimated waiting time if the customer arrives at the physical location of the service provider during the alternate time period.

4. The system of claim 3, wherein the module further causes the one or more processors to:
receive a response that the customer has accepted the guarantee for the waiting time that is less than the estimated waiting time;
identify the customer has arrived at the physical location of the service provider during the alternate time period; and
notify an agent of the service provider that the customer has arrived at the physical location of the service provider and that the customer has accepted the guarantee for the waiting time.

5. The system of claim 2, wherein the notification further comprises an estimated waiting time for an alternate physical location of the service provider.

6. The system of claim 2, wherein the module further causes the one or more processors to identify that the customer is capable of performing the recurring transaction using a remote application, wherein presenting the notification to the customer further comprises a set of instructions informing the customer how to perform the recurring transaction using the remote application.

7. The system of claim 2, the module further causes the one or more processors to establish a data connection between a computing device of the customer and a computing device of a remote agent of the financial institution capable of completing the recurring transaction, wherein the data connection transmits a multimedia signal that is presented on the computing device of the customer and the computing device of the remote agent, thereby allowing the remote agent to assist the customer in completing the recurring transaction.

8. The system of claim 2, wherein the module further cause the one or more processors to:
receive a geographic location of the customer determined by a mobile device of the customer, wherein the mobile device of the customer determines the geographic location of the customer by communicating with a global positioning device;
calculate an estimated travel time for the customer to arrive at the physical location of the service provider based on the traffic information of the area between the geographic location of the customer and the physical location of the service provider; and
communicate the estimated travel time for the customer to arrive at the physical location of the service provider.

9. A computer apparatus for managing waiting times at a physical location of a service provider, the computer apparatus comprising a non-transitory computer-readable medium comprising a set of codes for cause a computer to:
receive historical transaction information identifying transactions performed by a customer;
identify, from the transaction information, a pattern for a recurring transaction performed by the customer while at a physical location of a service provider;
determine an instance in the future when the customer will likely perform the recurring transaction at the physical location of the service provider;
receive waiting time information identifying typical waiting times at the physical location of the service provider;
identify, based on the waiting time information, an estimated waiting time for performing the recurring transaction during a period of time associated with the instance in the future when the customer will likely perform the recurring transaction;
identify, based on the waiting time information, an alternate time period comprising a waiting time less than the estimated waiting time; and
present, to the customer, a notification comprising the estimated waiting time for performing the recurring transaction during the period of time associated with the instance and the waiting time associated with the alternate time period, thereby managing the waiting times of the physical location of the service provider.

10. The computer program apparatus of claim 9, wherein the notification further provides a guarantee for a waiting time that is less than the estimated waiting time.

11. The computer program apparatus of claim 10, wherein the computer program product further comprises a set of code for causing computer to:
receive a response that the customer has accepted the guarantee for the waiting time that is less than the estimated waiting time;
identify the customer has arrived at the physical location of the service provider during the alternate time period; and
notify an agent of the service provider that the customer has arrived at the physical location of the service provider and that the customer has accepted the guarantee for the waiting time.

12. The computer program apparatus of claim 9, wherein the notification further comprises an estimated waiting time for an alternate physical location of the service provider.

13. The computer program apparatus of claim 9, wherein the computer program product further comprises a set of code for causing computer to identify that the customer is capable of performing the recurring transaction using a remote application, wherein presenting the notification to the customer further comprises a set of instructions informing the customer how to perform the recurring transaction using the remote application.

14. The computer program apparatus of claim 9, wherein the computer program product further comprises a set of code for causing computer to establish a data connection between a computing device of the customer and a computing device of a remote agent of the financial institution capable of completing the recurring transaction, wherein the data connection transmits a multimedia signal that is presented on the computing device of the customer and the computing device of the remote agent, thereby allowing the remote agent to assist the customer in completing the recurring transaction.

15. The computer program apparatus of claim 9, wherein the computer program product further comprises a set of code for causing computer to:
receive a geographic location of the customer determined by a mobile device of the customer, wherein the mobile device of the customer determines the geographic location of the customer by communicating with a global positioning device;
calculate an estimated travel time for the customer to arrive at the physical location of the service provider based on the traffic information of the area between the geographic location of the customer and the physical location of the service provider; and
communicate the estimated travel time for the customer to arrive at the physical location of the service provider.

16. A method for managing waiting times at a physical location of a service provider, the method comprising:
receiving historical transaction information identifying transactions performed by a customer;
identifying, from the transaction information, a pattern for a recurring transaction performed by the customer while at a physical location of a service provider;
determining an instance in the future when the customer will likely perform the recurring transaction at the physical location of the service provider;
receiving waiting time information identifying typical waiting times at the physical location of the service provider;
identifying, based on the waiting time information, an estimated waiting time for performing the recurring transaction during a period of time associated with the instance in the future when the customer will likely perform the recurring transaction;
identifying, based on the waiting time information, an alternate time period comprising a waiting time less than the estimated waiting time; and
presenting, to the customer, a notification comprising the estimated waiting time for performing the recurring transaction during the period of time associated with the instance and the waiting time associated with the alternate time period, thereby managing the waiting times of the physical location of the service provider.

17. The method of claim 16, wherein the notification further provides a guarantee for a waiting time that is less than the estimated waiting time.

18. The method of claim 17, wherein the method further comprising:
receiving a response that the customer has accepted the guarantee for the waiting time that is less than the estimated waiting time;
identify the customer has arrived at the physical location of the service provider during the alternate time period; and
notify an agent of the service provider that the customer has arrived at the physical location of the service provider and that the customer has accepted the guarantee for the waiting time.

19. The method of claim 16, wherein the notification further comprises an estimated waiting time for an alternate physical location of the service provider.

20. The method of claim 16, wherein the method further comprises identifying that the customer is capable of performing the recurring transaction using a remote application, wherein presenting the notification to the customer further comprises a set of instructions informing the customer how to perform the recurring transaction using the remote application.

21. The method of claim 16, wherein the method further comprises establishing a data connection between a computing device of the customer and a computing device of a remote agent of the financial institution capable of completing the recurring transaction, wherein the data connection transmits a multimedia signal that is presented on the computing device of the customer and the computing device of the remote agent, thereby allowing the remote agent to assist the customer in completing the recurring transaction.
